(19) United States
(12) Patent Application Publication
(10) Pub. No.: US 2008/0156903 A1
(43) Pub. Date: Jul. 3, 2008

(54) Hand Shower with An Extendable Handle

(76) Inventor: Leland C. Leber, Fort Collins, CO (US)

Correspondence Address: DORSEY & WHITNEY, LLP;INTELLECTUAL PROPERTY DEPARTMENT, 370 SEVENTEENTH STREET, SUITE 4700, DENVER, CO, 80202-5647, US

(21) Appl. No.: 11/965,223

(22) Filed: Dec. 27, 2007

Related U.S. Application Data
(60) Provisional application No. 60/882,414, filed on Dec. 28, 2006.

(51) Int. Cl. B05B 1/14

(52) U.S. Cl. 239/532; 4/615; 239/600; 29/890.1

(57) ABSTRACT

A handheld shower assembly is provided. The handheld shower assembly includes a water conduit, a handle, and a showerhead. The water conduit is adapted to attach to the showerhead at one end and to a water source extending from a wall of a shower stall at another end to receive water flow. The handle includes a first portion and a second portion adapted to accept the water conduit within an interior portion of the handle. The first portion is adjustably coupled to the second portion. This allows the first portion to telescope with respect to the second portion, thereby the first portion extends from a first retracted position to a second extended position. The showerhead is coupled to the water conduit and the handle. The showerhead may receive the water flow from the water conduit as well as expelling the water flow.

### CROSS REFERENCE TO RELATED APPLICATION(S)

This application claims benefit under 35 U.S.C. §119(e) to U.S. Ser. No. 60/882,414, entitled “Hand Shower with an Extendable Handle”, filed Dec. 28, 2006 (attorney docket number 187981/US), the contents of which are incorporated herein by reference in their entirety.

### FIELD OF THE INVENTION

The present invention relates to a handheld shower assembly. More specifically, the present invention relates to an adjustable handle configuration.

### BACKGROUND OF THE INVENTION

Generally, handheld shower assemblies are used to direct water from a home water supply for personal hygiene purposes. As handheld shower assemblies increase in popularity, demand for new and innovative designs for handheld shower assemblies also increase. Over time, several possible shortcomings have been identified with existing handheld shower assembly designs. For example, many existing handheld shower assemblies have a fixed length preventing an attached shower handle from extending along the axial length of the assembly. Additionally, many handheld shower assemblies do not provide adjustable handles sufficient or long enough for a user to direct the water delivery angle onto remote areas of the body, such as one's back.

Accordingly, there is need in the art for a handheld shower assembly with an angularly adjustable handle that allows repositioning of a showerhead. There is also need in the art for a handheld shower assembly having an adjustable length handle.

### SUMMARY

One exemplary embodiment of the present invention takes the form of a handheld shower assembly. The handheld shower assembly may include a water conduit, an adjustable handle, and a showerhead. The water conduit is adapted to attach to a standard shower pipe extending from a wall of a shower stall and receives water flow from the shower pipe. The handle includes a first portion and a second portion adapted to receive the water conduit in an interior handle portion. The first portion is adjustably coupled to the second portion. The first portion may telescope with respect to the second portion, thereby the first portion extends from a first retracted position to a second extended position. The showerhead is operably coupled to the water conduit and the handle and may receive water flow from the water conduit as well as expel water.

A second embodiment of the present invention may take the form of a method for manufacturing a handheld shower assembly. The method may include coupling a first portion and a second portion to form an adjustable handle in which the first portion slides from a first retracted position to a second extended position. The first portion extends at least partly outwardly from the second portion when in the first position and retraced at least partly within the second portion relative to the first portion when in the second position. The method may also include coupling a showerhead to a hose extending through an interior of the adjustable handle. The hose is adapted to receive and transport water from a water source to the showerhead, and the showerhead is configured to distribute the water flow. The method may further include coupling the showerhead to the adjustable handle in a manner that allows the angle of water flow distribution to be adjusted in response to axially adjusting the handle.

While multiple embodiments of the present invention are disclosed herein, still other embodiments of the present invention will become apparent to those skilled in the art from the following detailed description, which shows and describes illustrative embodiments of the invention. As will be realized, by those of ordinary skill in the art upon reading the following disclosure, the invention is capable of modifications in various aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is perspective view of a handheld shower assembly having an adjustable handle shown in a first position, in accordance with an exemplary embodiment of the present invention.

FIG. 2 is a cross-sectional view of the handheld shower assembly of FIG. 1, taken along lines 2-2 of FIG. 1.

FIG. 3 is a perspective view of a showerhead of the handheld shower assembly of FIG. 1.

FIG. 4 is a perspective view of the handheld shower assembly of FIG. 1 with the adjustable handle shown in a second position, in accordance with the exemplary embodiment of the present invention.

FIG. 5 is a cross-sectional view of the handheld shower assembly with the handle in the second position taken along lines 5-5 of FIG. 4.

FIG. 6 is a partially exploded view of the handheld shower assembly.

FIG. 7 is a perspective view of a first half of a lower member of the adjustable handle.

FIG. 8 is a cross-sectional view of the handle taken along lines 8-8 of FIG. 2.

FIG. 9 is a cross-sectional view of the handle taken along lines 9-9 of FIG. 2.

FIG. 10 is a cross-sectional view of the handle taken along lines 10-10 of FIG. 2.

FIG. 11 is a cross-sectional view of an upper member of the handle taken along lines 11-11 of FIG. 5.

FIG. 12 is perspective view of the adjustable handle of FIG. 1 having a first embodiment of a locking mechanism with the handle shown in the first position.

FIG. 13 is a perspective view of the adjustable handle having the first locking mechanism with the handle shown in the second position.

FIG. 14 is a partial cross-sectional view of the adjustable handle having the first locking mechanism with the handle shown in the second position taken along lines 14-14 of FIG. 13.

FIG. 15 is a perspective view of the adjustable handle having a second embodiment of a locking mechanism with the handle shown in the second position.

FIG. 16 is a perspective view of the second embodiment of the locking mechanism of FIG. 15 in a locked position.

FIG. 17 is a perspective view of the second embodiment of the locking mechanism of FIG. 15 in an unlocked position.

FIG. 18 is a cross-sectional view of the handle having the locking mechanism in the locked position taken along lines 18-18 of FIG. 16.

FIG. 19 is a cross-sectional view of the handle having the locking mechanism taken along lines 19-19 of FIG. 18.

FIG. 20 is a cross-sectional view of the handle having the locking mechanism in the unlocked position taken along lines 20-20 of FIG. 17.

FIG. 21 is a cross-sectional view of the handle having the locking mechanism taken along lines 21-21 of FIG. 20.

FIG. 22 is a cross-sectional view of the handheld shower assembly and a bracket arrangement with the handle in the second position taken along lines 5-5 of FIG. 4.

### DETAILED DESCRIPTION

The present application discloses a handheld shower assembly 10. The handheld shower assembly 10 includes an adjustable handle that allows a user to manipulate an overall length of the adjustable handle. The following paragraphs provide a detailed description of the handheld shower assembly 10.

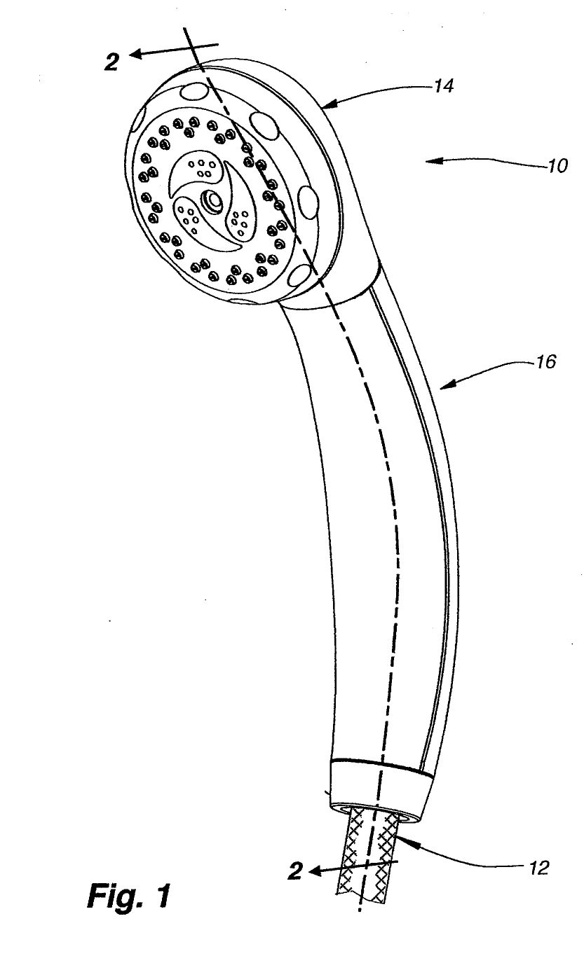

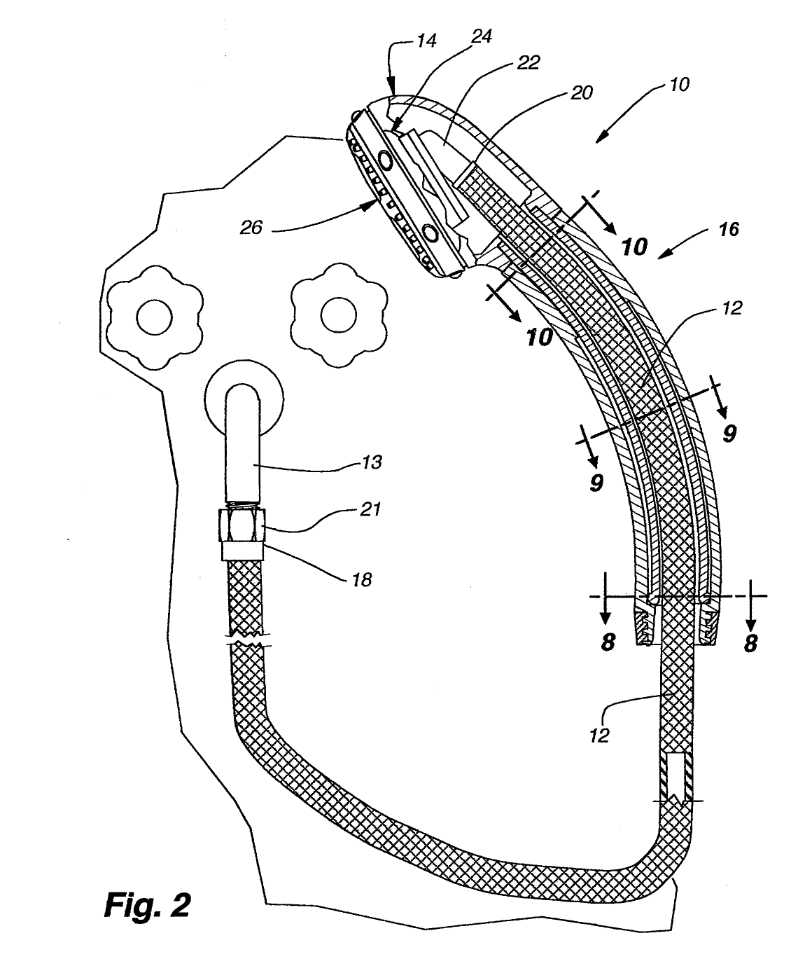

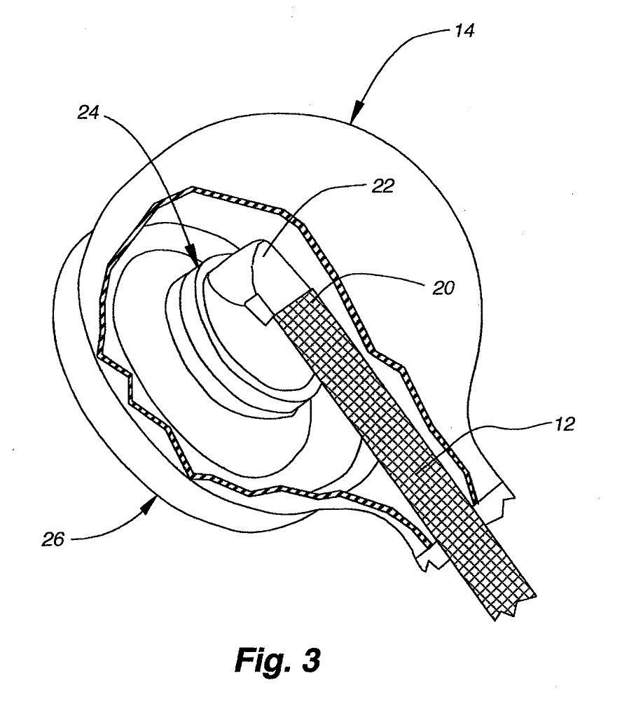

One exemplary embodiment of the handheld shower assembly 10 is described herein with respect to FIGS. 1-4. FIG. 1 is a perspective view of the handheld shower assembly 10. As shown in FIG. 1, the handheld shower assembly 10 may include a water conduit 12, a showerhead 14, and an adjustable handle 16 occupying a first or retracted position. FIG. 2 is an illustration of a cross-sectional view of the handheld shower assembly 10 of FIG. 1 taken along lines 2-2 in FIG. 1. Coupled to one end of the water conduit 12 is a standard shower pipe 13 extending, for example, from a wall. According to this configuration, water conduit 12 extends from a water source, through the adjustable handle 16 of shower assembly 10, and is coupled to showerhead 14 to form a water-tight seal (See FIG. 3).

According to implementations of the invention, a single water-tight connection or seal is formed, e.g., between water conduit 12 and showerhead 14, as opposed to providing multiple water-tight seals between, for example, a terminal end of water conduit 12 and an end of the adjustable handle 16 closest to a water source, between overlapping portions of adjustable handle 16, and between the end of adjustable handle 16 closest to showerhead 14 and showerhead 14. Each of the above-described water-tight connections has a potential for failure, and as a result, providing as few water connections as possible, like in the present invention, is desirable. Thus, according to further implementations, water conduit 12 and the portion of showerhead 14 connected thereto may be formed as a unitary piece or may be welded, secured or locked together.

In addition, by providing a seal between water conduit 12 and showerhead 14, water pressure is not exerted on the movable joints of the adjustable handle 16. Accordingly, issues associated with wear and tear between joints of the adjustable handle 16 due to the force of water pressure in an interior of the handle are avoided.

Furthermore, by providing a connection to the water conduit 12 at showerhead 14, issues associated with water pressure within a telescoping shower handle are avoided. That is, if water conduit 12 were coupled to the end of adjustable handle 16 closest to shower pipe 13, water pressure within the adjustable handle 16 would need to be maintained by providing multiple water-tight seals between overlapping portions of the adjustable handle, showerhead and water conduit and the adjustable handle would need to be locked into place before pressurizing the assembly in order to avoid the assembly from extending to its maximum distance due to the internal water pressure differential.

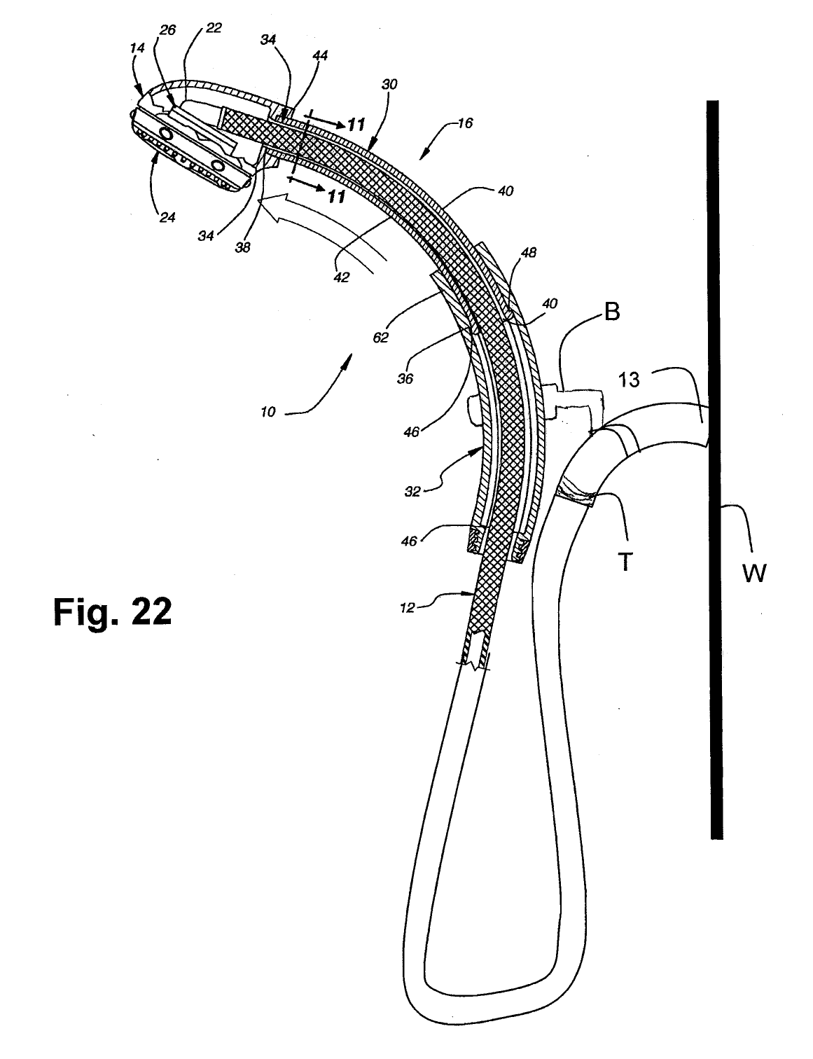

In alternative configurations, conduit 12 may be coupled at one end to a bath tub faucet or a shower pipe via a bracket (shown in FIG. 22) and at a second end to showerhead 14. However, in each of the above-described configurations, water conduit 12 transports water from the shower pipe 13, through an overall length of the adjustable handle 16, and to the showerhead 14, where a water-tight connection is formed between water conduit 12 and showerhead 14.

Water conduit 12 is a flexible hose, preferably made of nylon-reinforced PVC, and has first and second opposing ends 18, 20. The first end 18 attaches to a standard shower pipe 13 extending from the wall of the shower stall via shower-pipe-connector nut 21. The second end 20 couples to the showerhead 14 via connecting structure 22. Between its connection points, water conduit 12 extends through adjustable handle 16 where more or less of water conduit 12 is housed within adjustable handle 16 depending on the position of adjustable handle 16.

Showerhead 14 receives water from the water conduit 12 and disperses water in a spray pattern at a spray angle that may be adjusted, according to certain embodiments of the invention. The showerhead 14 includes a receiving portion 24 (FIG. 3) and a fluid dispersing portion 26 (FIG. 2). Using the connection structure 22, the water conduit 12 is attached to the receiving portion 24, such that the receiving portion 24 receives water from the water conduit 12. As water is received in the showerhead 14, the water flows out of the fluid dispersing portion 26 in a spray pattern at a first spray angle. Showerhead 14 may include any conventional showerhead that is used in conjunction with a conventional handheld shower assembly.

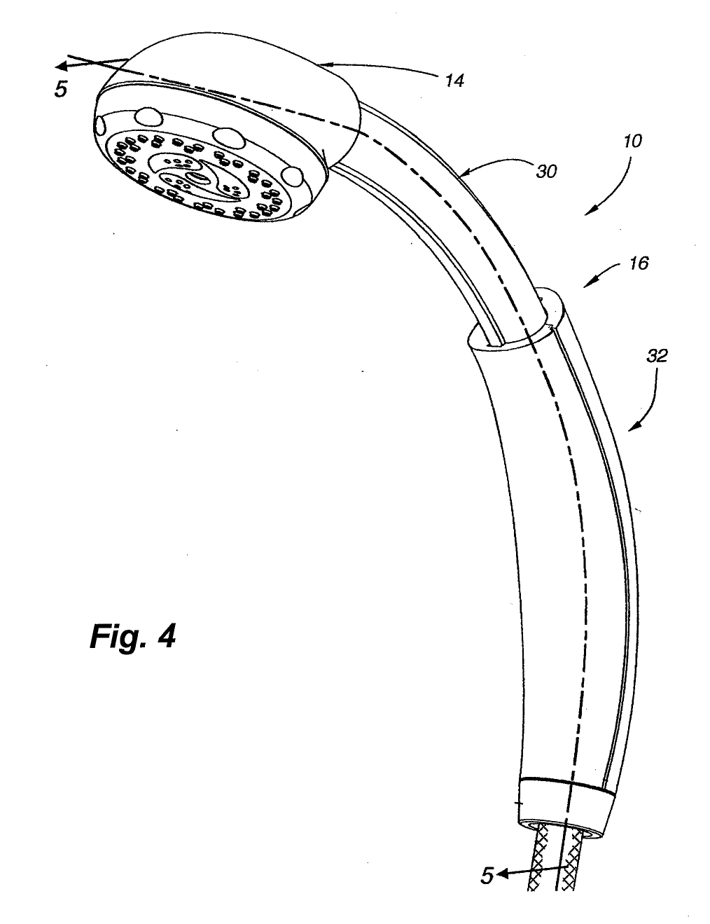

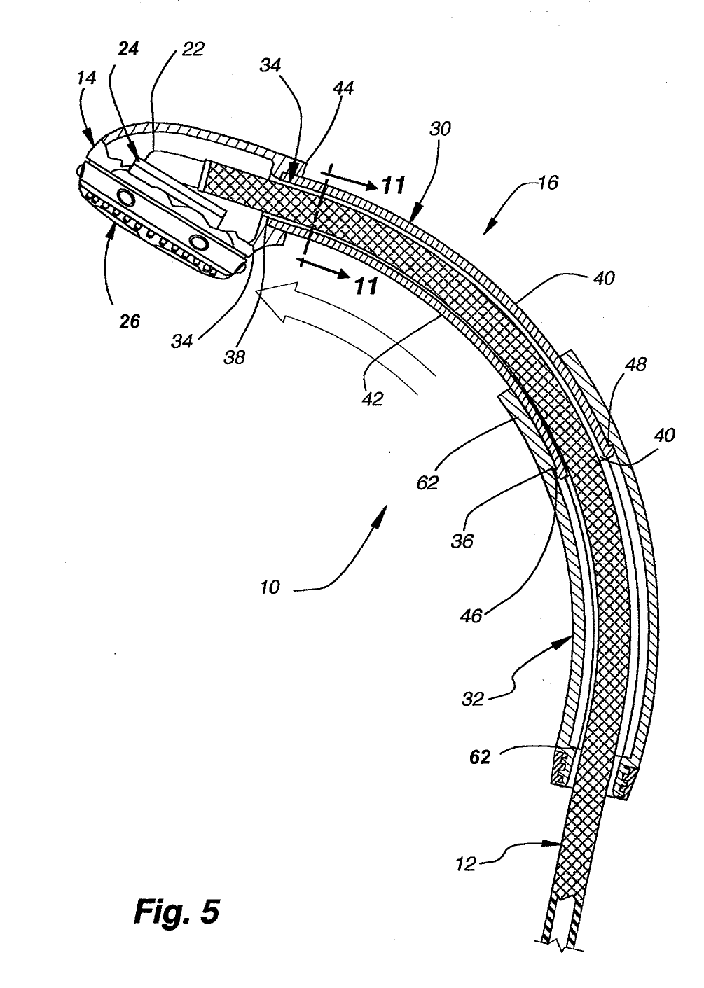

Adjustable handle 16, as depicted in FIGS. 4 and 5, may occupy a second or extended position. The adjustable handle 16 includes a first, or upper, handle member 30 and a second, or lower, handle member 32. The upper handle member 30 is coupled to the lower handle member 32 at a first end, such that the upper handle member 30 slides within the lower handle member 32 to adjust the overall length of the adjustable handle 16. For example, and as described in more detail below, the adjustable handle 16 may occupy a fully retracted position (as shown in FIG. 1), a fully extended position (as shown in FIG. 4), or one or more intermediate positions. Alternatively, the lower handle member 32 may be configured to slide within the upper handle member 30 instead of the upper handle member 30 sliding within the lower handle member 32.

According to certain implementations, and as shown in FIGS. 4 and 5, showerhead 14 is fixedly secured to upper handle member 30 so that the position of showerhead 14 relative to upper handle member 30 may not be altered. In further implementations, showerhead 14 may be rotatably secured to upper handle member 30 so that showerhead 14 can be moved about a single axis of rotation relative to upper handle member 30. Showerhead 14 may also be pivotable relative to the end of upper handle member 30, allowing for angular adjustment of showerhead 14 such that fluid dispersing portion 26 may deliver water in a spray pattern at a number of spray angles.

According to one implementation, upper handle member 30 may be contoured to a cylindrical shape having a longitudinal axis. More specifically, the upper handle member 30 may form a curvilinear cylindrical shape. Alternatively, the upper handle member 30 may form a linear cylindrical shape. The shape of the upper handle member 30 is configured to aid in producing a desired spray angle of the water dispersed by the showerhead 14. For example, if the adjustable handle 16 comprises the curvilinear cylindrical shape and the adjustable handle 16 occupies the retracted position, e.g., upper handle member 30 is arranged in the interior of lower handle member 32, the showerhead 14 emits the water at a first, or side, angle (FIG. 1). After repositioning the upper handle member 30 from the retracted position to the extended position, the spray angle of the showerhead 14 is also repositioned from the first angle to a second, or overhead, angle (FIG. 4). In addition, when upper handle member 30 is situated in-between the retracted and extended position, the spray angle of the showerhead 14 may deliver water at one of various angles between the first and second, overhead angle. The upper handle member 30 may be made of a metallic material. Alternatively, the upper handle member 30 may be made of a polymeric material.

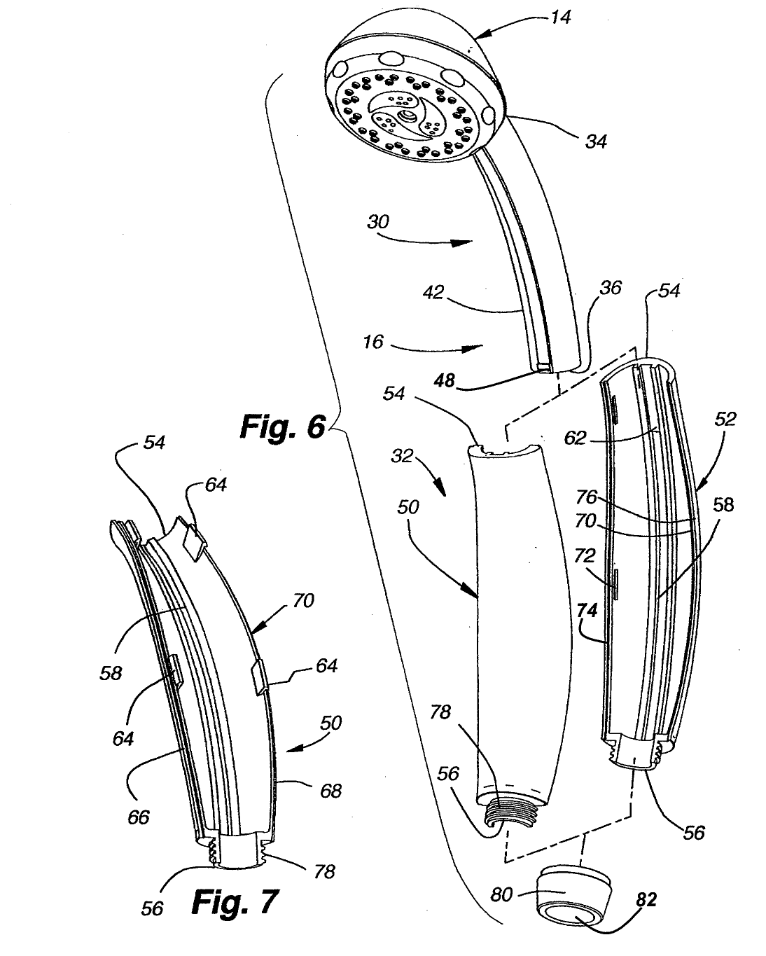

As best shown in FIGS. 5-6, the lower handle member 32 is conformed to a cylindrical body having a longitudinal axis. The cylindrical body includes a curvilinear shape. Alternatively, the cylindrical body may include a linear shape. As previously mentioned, the shape of the upper handle member 30 aids in providing the spray angle of the water dispersed from the showerhead 14. Likewise, the lower handle member 32 also aids in repositioning the spray angle of the water by the showerhead 14.

Accordingly, in certain implementations, the upper and lower handle members 30, 32 may be contoured to the same or similar shapes. Alternatively, the upper and lower handle members 30, 32 may be configured to have different shapes. When the upper handle member 30 and the lower handle member 32 comprise a curvilinear shape, the upper handle member 30 telescopes from the extended position (FIG. 4) to the retracted position (FIG. 1), or vice versa along a curved trajectory. This allows the showerhead 14 to change the spray angle of the water emanating from the showerhead 14. For example, if the upper handle member 30 telescopes from the retracted position to the extended position, the spray angle may change the water flow from a side angle to an overhead angle.

In FIG. 5, the upper handle member 30 includes an opposing first end 34 and second end 36. The first end 34 includes an aperture 38 that extends a length of the upper handle member 30 to the second end 36 forming a hollow chamber 40. The hollow chamber is sized to house the water conduit 12 within the upper handle member 30. The first end 34 is coupled to the showerhead 14. The second end 36 of the upper handle member 30 is coupled to the lower handle member 32.

As best shown in FIGS. 5 and 11, the upper handle member 30 may also include a first guiding track 40 and a second guiding track 42. The tracks 40, 42 are located on a surface of the upper handle member 30 along a longitudinal axis. Additionally, the tracks 40, 42 are parallel and located on opposing sides of the upper handle member 30. Each track 40, 42 includes a first end 44 and a second end 46. In FIG. 5, tracks 40, 42 follow the contour of upper handle member 30, and at the second end 46, tracks 40, 42 include a stepped, wedged, or notched surface 48. Alternatively, the second end 46 may include a stepped or wedged ring. The functionality of the notched surface 48 in relation to the lower handle member 32 will be further described in the discussion of FIGS. 6-7.

In FIGS. 6-7, lower handle member 32 includes a first half 50 and a second half 52, each with an opposing first end 54 and second end 56. The receiving track 58 of the first half 50 and second half 52 are on interior surfaces of lower handle member 32. As the upper handle member 30 is telescoped within the lower handle member 32, this interconnection between the receiving tracks 58 and the guiding tracks 40, 42 allows the upper handle member 30 to slide relative to the lower handle member 32 along a predetermined path. According to certain embodiments, receiving track 58 may be configured with a complementary shape relative to its respective guiding track 40, 42.

At the first end 54 of first and second halves 50, 52, each receiving track 58 includes a ledge, or wedge, portion 62 that extends from an inner surface of the first and second halves 50, 52. As the upper handle member 30 is slid from the retracted position to the extended position, or vice versa, the guiding tracks 40, 42 travel along the receiving tracks 58 until the notched surface 48 abuts against the ledge portion 62. The ledge portion 62 restricts the travel of the upper handle member 30 and prevents the upper handle member from decoupling from the lower handle member 32.

According to FIGS. 6-7, the interior of the first half 50 of lower handle member 32 includes a plurality of clips 64. Clips 64 are disposed on longitudinal edges 66, 68 of the first half 50. In FIGS. 6 and 7, the first half 50 is approximately half-circular in lateral cross-section and the clips 64 are formed at opposing edges of the half-circle shape. One pair of clips 64 are formed at the first end 54 of the first half 50 and another pair 64 at a mid-portion 70 of the first half 50. In other implementations, the shape of first half 50 and the location and/or shape of the clips 64 may vary.

The interior of the second half 52 of lower handle member 32 includes a set of complementary recesses 72 disposed on longitudinal edges 74, 76. In FIGS. 6 and 7, the second half 52 is approximately half-circular in lateral cross-section and the recesses 72 are formed at opposing edges of the half-circle shape. One pair of recesses 72 is formed at or near the first end 52 and another pair of the recesses 72 are formed at or near the mid-portion 70 of the second half 52. In an alternative embodiment, the shape of the second half 52 and the location and/or shape of the recesses 72 may vary. When the first half 50 and the second half 52 are combined, the clips 64 are inserted into the recesses 72 to secure the first half 50 to the second half 52. Alternatively, the first half 50 and the second half 52 may be combined to form the lower handle member 32 using adhesive, thermal bond, sonic weld, or at least one clamp or fastener.

The second end 56 of first half 50 and second half 52 includes a threaded portion 78. The threaded portion 78 is configured to receive a threaded connecting nut 80 in order to further secure the first half 50 to the second half 52. Additionally, a portion of the water conduit 12 extends through an aperture 82 of the nut 80.

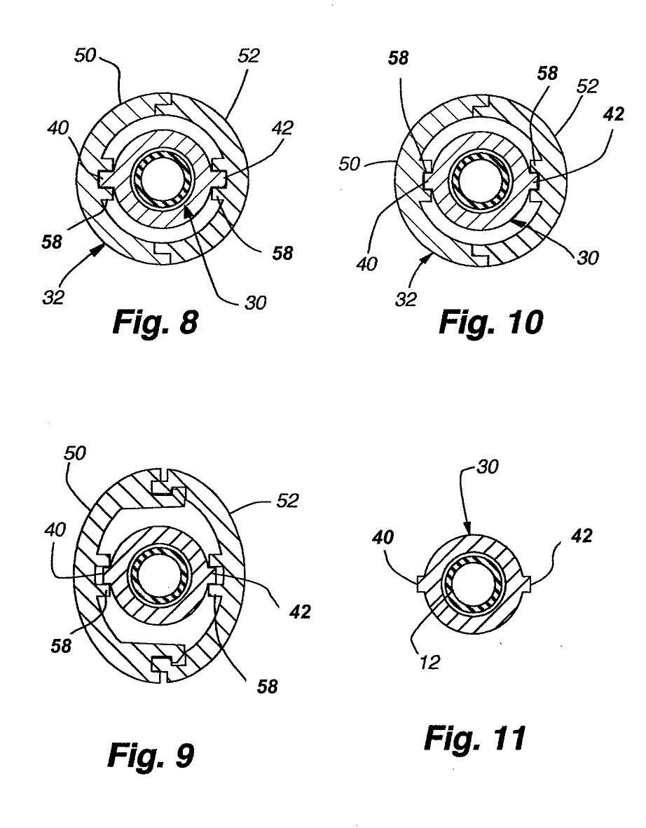

Referring to FIGS. 8-11, cross-sectional views of the handheld assembly 10 are disclosed wherein each of the first and second halves 50, 52 includes a receiving track 58 to receive a corresponding guiding track 40, 42 of the upper handle member 30. In particular, FIGS. 8-10 disclose cross sectional views of the handle 16, thereby illustrating the interconnection of the receiving tracks 58 and the guiding tracks 40, 42. This interconnection may prevent the upper handle member 30 from twisting or rotating along a non-longitudinal axis. In addition, receiving tracks 58 and guiding tracks 40, 42 are configured such that a friction lock is formed between upper and lower handle member when adjustable handle member 16 is set to a desired position. As a result, upper handle member 30 and lower handle member 32 remain in the desired position until a user alters their relative position. Further, from FIGS. 8-10, the shape of lower handle portion 32 first and second half 50, 52 changes from a cylindrical tube shape (FIG. 8) to an oblong shape (FIG. 9) and back to a cylindrical tube shape (FIG. 10), which may provide a user with a surface that is easy to hold and contoured for the user's hand when gripping the handheld assembly. It will be understood, however, that the exterior surface of first and second half 50, 52 may be configured with any suitable shape, and may include features such as ridges, relief spots, finger and thumb impressions, or other tactile items.

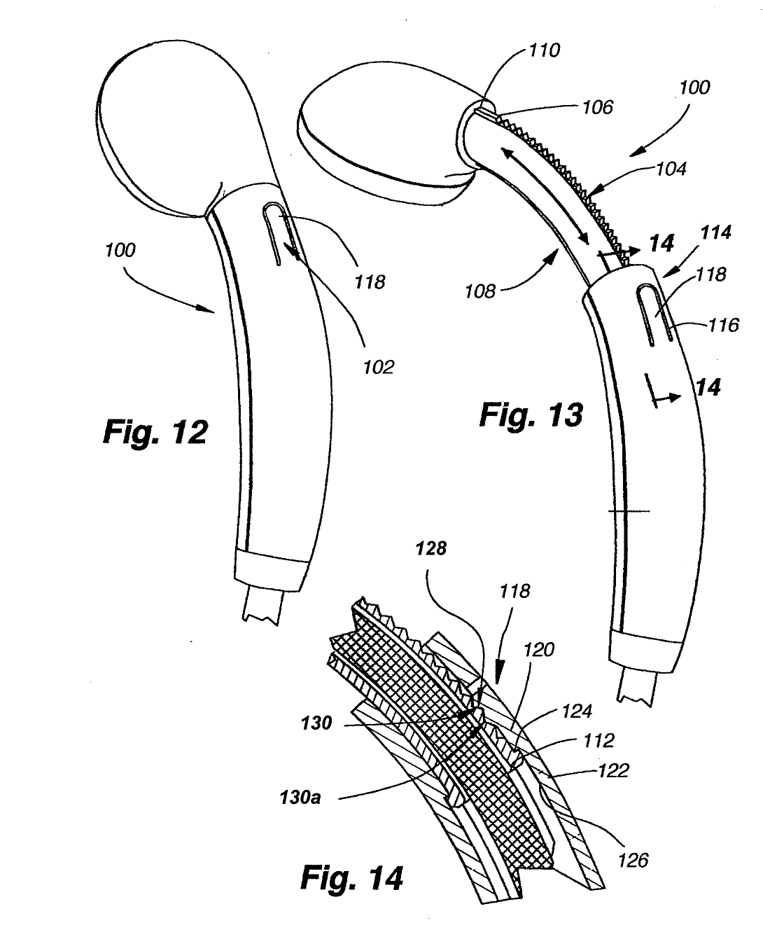

FIG. 12 provides an illustration of a perspective view of another embodiment of a handheld shower assembly that includes an exemplary locking mechanism. In FIG. 12, handheld shower assembly 100 is a fixed incremental locking mechanism 102 shown in the retracted position. In the extended position, as seen in FIG. 13, the locking mechanism 102 includes guiding track 106 configured as a tooth track 104 and a latching lock 118 configured to engage the tooth track 104. The tooth tracks 104 extend from a first end 110 of the guiding tracks 106 to a notched surface 112 that is used to prevent the upper handle member 108 from disconnecting from a lower handle member 114.

The lower handle member 114 includes an opening 116 forming a U-shaped pattern, and the area formed by the boundaries of the U-shaped pattern defines the latching lock 118. The latching lock 118 has a first material thickness 120 and a second material thickness 122. A portion of latching lock 118 corresponding to the first material thickness 120 forms a ledge portion 124, and is thicker than the portion of latching lock 118 corresponding to the second material thickness 122 located at an inner surface 126 of the lower handle member 114. In the thinner area of the second material thickness 122, latching lock 118 is elastically flexible as the upper handle member 108 is telescoped relative to the lower handle member 114. In the thicker area of the first material thickness 120, latching lock 118 includes a keyed feature 128 configured to have a structure that is complementary and engageable with teeth 130 of tooth track 104.

In FIG. 14, the partial cross-sectional view of handheld shower assembly 100 in the extended position is taken along lines 14-14 of FIG. 13 and depicts latching lock 118 with a keyed feature 128. The keyed feature 128, configured complementary to the tooth track 104, engages and disengages each tooth 130 along the tooth track 104 as the upper handle member 108 is telescoped within the lower handle member 114 from one position to another position, e.g., collapsed to extended position or partially extended to collapsed position. In operation, a user grips the showerhead proximate first end 110 of guiding tracks with one hand and grips the lower handle member 114 with the other and pulls or pushes the two portions apart or together. Once upper handle member 108 is in a desirable position, the user releases the showerhead, and the keyed feature 128 remains engaged with a particular tooth 130a of the tooth track 104 to secure the upper handle member 108 relative to the lower handle member 114 in the desired position.

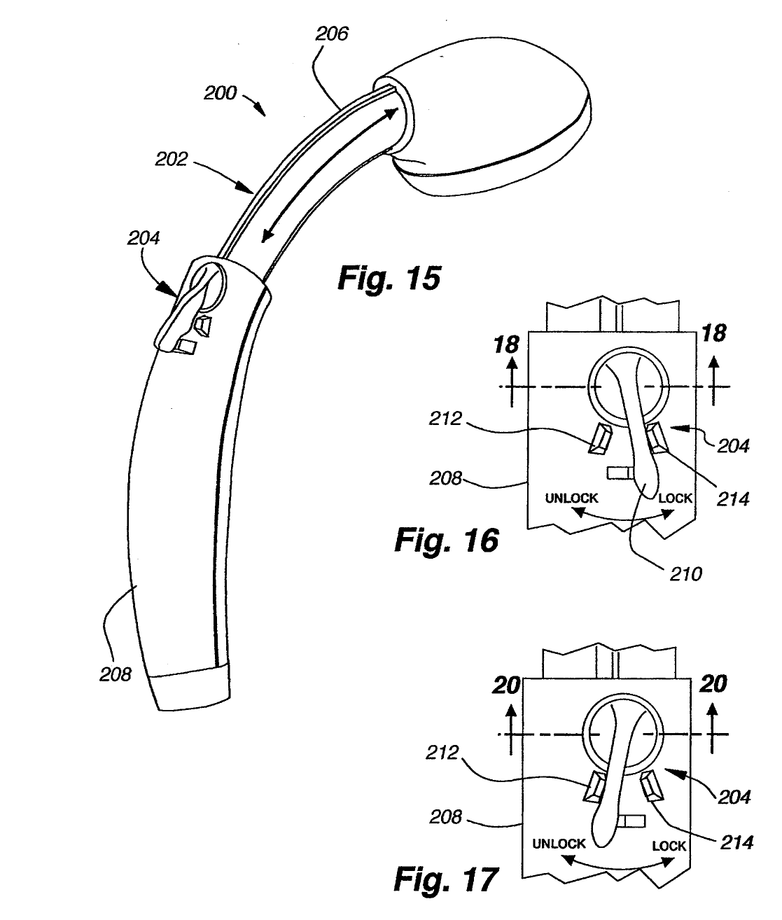

FIG. 15 depicts a third exemplary embodiment of the handheld shower assembly having another exemplary locking mechanism. In FIG. 15, the handheld shower assembly 200 includes an adjustable handle 202 in an extended position. Coupled to the adjustable handle 202 is a variable adjusting locking mechanism 204 disposed on lower handle member 208 that is rotatable to a locked and unlocked position. The locking mechanism 204 is configured to allow the upper handle member 206 to be variably adjusted relative to the lower handle member 208 when transitioning from one position to another position.

According to FIGS. 16 and 17, the locking mechanism 204 includes a lever 210 configured to switch between a first or locked position and a second or unlocked position. The locking mechanism 204 also may include a first stopper block 212 and a second stopper block 214 located on opposite sides of the lever 210. The stopper blocks 212, 214 prevent the lever 210 from rotating beyond a locking or unlocking position and provide a visual indicator to a user when the lever 210 has locked or unlocked the upper handle member 206 for adjusting the overall length of the handle 202. If the lever 210 is switched to the locked position (FIG. 16), the upper handle member 206 is locked or secured in the desired position. On the other hand, if the lever 210 is switched in the unlocked position (FIG. 17), the upper handle member 206 is capable of telescoping relative to the lower handle member 208 in order to modify the overall length of the adjustable handle 202. Further, when the lever 210 is in the unlocked position, a user may freely move upper handle member 206 relative to the lower handle member 208 to any desired length, e.g., any length between a collapsed position, like in FIG. 1, to a fully extended position, like in FIG. 15 . Accordingly, when lever 210 is in the unlocked position, handheld shower assembly 200 is operable in a substantially similar manner as handheld shower assembly 10.

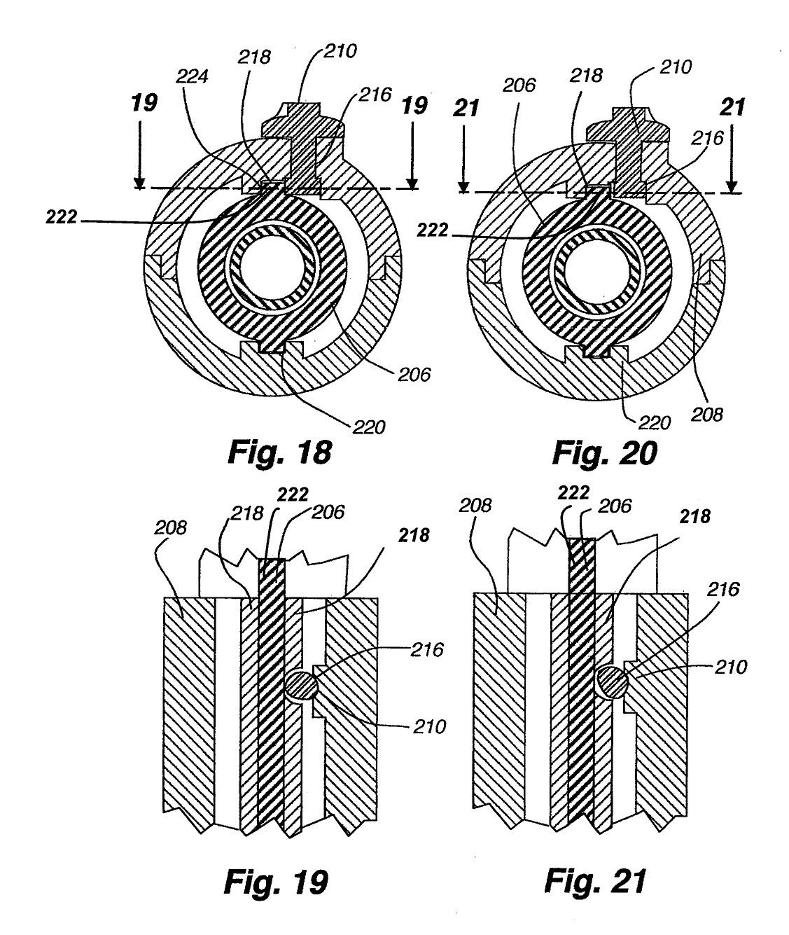

FIGS. 18-19 illustrate cross-sectional views of the adjustable handle 202 with a key 216 of the locking mechanism 204 in the locked position. A receiving track 218 is wider than a second receiving track 220. The receiving track 218 is configured to receive the key 216 and a guiding track 222 of the upper handle member 206, wherein the key 216 abuts against the guiding track 222, securing guiding track between key 216 and adjoining wall 224. This action causes the key 216 to secure and restrict movement of the upper handle member 206 relative to the lower handle member 208.

As best shown in FIGS. 20-21, cross-sectional views of the adjustable handle 202 having the key 216 in the unlocked position. When the lever 210 is switched to the unlocked position, the key 216 releases the guiding track 222. This allows the upper handle member 206 to telescope relative to the lower handle member 208 in order to adjust the overall length of the adjustable handle 202.

It will be understood that locking mechanisms including those described above may be located on any portion of handheld shower assembly 10. For example, a locking mechanism may be located at the top, middle or bottom of lower handle member 32, either at a front or back side, e.g., at either first half 50 or second half 52. When a locking mechanism is partially arranged at a second end 56 of the lower handle member 32, a lever or pulley system (not shown) may be employed in order to release and secure an engagement with the upper handle 30 member near the first end 54 of the lower handle member 32. As a result, nearly the entire length of upper handle member 30 may be extended from lower handle member even when a portion of the locking mechanism is located at a second end of the lower handle member 32.

FIG. 22 is a cross-sectional view of the handheld shower assembly 10 and a bracket arrangement B with the handle in the second position taken along lines 5-5 of FIG. 4. In FIG. 22, bracket arrangement B is coupled at one end to shower pipe 13 extending from wall W and at another end to shower assembly 10 at lower handle member 32. In alternative configurations, bracket arrangement B may be coupled to wall W, to threading T of shower pipe 13, or to water conduit 12, for example, in an area proximate shower pipe 13. In use, bracket arrangement B holds shower assembly at an angle that facilitates delivering spray to a user. As shower assembly 10 is moved from a first to a second position, or vice versa, the spray angle delivered to the user changes. For example, moving shower assembly 10 outward and forward to the second angle as shown in FIG. 22 results in water delivery at an overhead angle. Alternatively, shower assembly 10 may be moved inward and backward to its first position as shown in FIG. 1 in order to deliver water at a side spray delivery angle.

The invention described herein provides a novel handheld shower assembly. The shower assembly includes an adjustable handle having an upper member and a lower member. Adjustably attached to one another, the upper member telescopes relative to the lower member. This allows a user the ability to manipulate and adjust an overall length of the adjustable handle along with the spray angle of the fluid dispensing portion. Although an upper and lower handle member have been described herein, additional handle members, e.g., a third, fourth or fifth handle member is contemplated. For example, a third or intermediate handle member may be disposed between the upper and lower handle member allowing for additional telescoping and thus angular adjustment of the spray angle from the fluid dispensing portion. In a further embodiment, a third or intermediate handle member may be lockable via a locking mechanism.

The ability to adjust the spray angle of the handheld shower assembly provides certain advantages for a user. For example, some individuals have limited range of motion in their arms and are unable to raise their arm to a height that allows the use of a traditional handheld shower. Furthermore, some users may engage in bathing a child or an elderly person and may find reaching areas of the body difficult using a traditional handheld shower. The additional length provided by the handheld shower assembly of the present invention may provide such a user with the distance needed to effectively wash more distant areas of their or another's body, e.g. the back. Furthermore, the angular adjustment provided by extending and retracting the handheld shower assembly allows a the assembly to be held in a bracket or in a user's hand at one angle while delivering water at a various spray angles.

Although the present invention has been described with reference to preferred embodiments, persons skilled in the art will recognize that changes may be made in form and detail without departing from the spirit and scope of the invention.

What is claimed is:

1. A handheld shower assembly comprising:
a handle having a first portion and a second portion, the first portion slidably attached to the second portion, wherein the first portion is operative to move between at least a first position to a second position along a longitudinal axis with respect to the second portion, the first portion extending at least a portion outwardly from the second portion when in the first position and retracted at least partly within the second portion relative to the first position when in the second position;
a showerhead coupled to the handle configured to distribute water; and
a hose adapted to receive and transport water from a water source to the showerhead, said hose extending through an interior of the handle and coupling to the showerhead.

2. The handheld shower assembly of claim 1, wherein the first portion comprises a curvilinear body.

3. The handheld shower assembly of claim 1, wherein the first portion comprises a linear body.

4. The handheld shower assembly of claim 1, wherein the second portion comprises a curvilinear body.

5. The handheld shower assembly of claim 1, wherein the second portion comprises a linear body.

6. The handheld shower assembly of claim 1, wherein the showerhead is coupled to the first portion of the handle.

7. The handheld shower assembly of claim 1, wherein when the first portion is in the first position, said first portion is arranged relative to the second portion at a first angle, and wherein when the first portion is in the second position, said first portion is arranged relative to the second portion at a second angle different from the first angle.

8. The handheld shower assembly of claim 7, wherein the second angle comprises an angle for delivering an overhead shower spray angle.

9. The handheld shower assembly of claim 7, wherein the first angle comprises an angle for delivering a side spray angle.

10. The handheld shower assembly of claim 1, wherein the handle further comprises a locking mechanism to secure the first portion relative to the second portion in the second position.

11. The handheld shower assembly of claim 10, wherein the locking mechanism is configured to allow the first portion to variably adjust relative to the second portion from the first position to the second position.

12. The handheld shower assembly of claim 10, wherein the locking mechanism is configured to allow the first portion to adjust relative to the second portion in fixed incremental steps when transitioning from the first position to the second position.

13. A method of manufacturing a handheld shower assembly comprising:
coupling a first portion to a second portion to form an adjustable handle, wherein the first portion is operative to slide between at least a first position to a second position with respect to the second portion, the first portion extending at least a partly outwardly from the second portion when in the first position and retracted at least partly within the second portion relative to the first position when in the second position;
coupling a showerhead to a hose, said hose extending through the adjustable handle and adapted to receive and transport water from a water source to the showerhead, wherein the showerhead is configured to distribute water, and
coupling the showerhead to the handle.

14. The method of claim 13, wherein coupling the first portion and the second portion further comprises coupling the first portion having a linear body to the second portion.

15. The method of claim 13, wherein coupling the first portion and the second portion further comprises coupling the first portion having a curvilinear body to the second portion.

16. The method of claim 13, wherein coupling the first portion and the second portion further comprises coupling the second portion having a linear body to the first portion.

17. The method of claim 13, wherein coupling the first portion and the second portion further comprises coupling the second portion having a curvilinear body to the first portion.

18. The method of claim 13, wherein coupling the first portion and the second portion further comprises coupling a locking mechanism between the first portion and the second portion to adjust and secure the first portion relative to the second portion in the second position.

19. The method of claim 18, wherein coupling the locking mechanism further comprises coupling the locking mechanism between the first portion and the second portion that is configured to allow the first portion to variably adjust and secure an overall length of the handle when transiting from the first position to the second position.

20. The method of claim 18, wherein coupling the locking mechanism further comprises configuring the locking mechanism between the first portion and the second portion that is configured to adjust and secure the first portion in the second position relative to the second portion in fixed incremental adjustments.

21. The method of claim 13, wherein coupling the first portion and the second portion further comprises coupling the first portion and the second portion such that when the first portion slides between the first position and the second position, an overall length of the handle is modified.

22. The method of claim 13, wherein coupling the first portion and the second portion further comprises coupling the first portion to the second portion such that when the first portion slides between the first position and the second position, the water dispersed by the showerhead changes from a first spray angle to a second spray angle.
